(19) United States
(12) Patent Application Publication
(10) Pub. No.: US 2023/0329293 A1
(43) Pub. Date: Oct. 19, 2023

(54) EGG SUBSTITUTE PRODUCT, METHOD FOR PRODUCING SUCH AN EGG SUBSTITUTE PRODUCT AND USE OF SUCH AN EGG SUBSTITUTE PRODUCT

(71) Applicant: Silvan LEIBACHER, Zurich (CH)

(72) Inventor: Silvan LEIBACHER, Zurich (CH)

(21) Appl. No.: 18/178,327

(22) Filed: Mar. 3, 2023

(30) Foreign Application Priority Data
Mar. 4, 2022 (EP) 22020091.9

(51) Int. Cl. A23L 15/00; A23J 1/14; A23L 29/212; A23L 29/10

(52) U.S. Cl. CPC A23L 15/35; A23J 1/14; A23L 29/212; A23L 29/10

(57) ABSTRACT

The invention relates to an egg substitute product for whole chicken eggs, chicken egg albumen or chicken egg yolks and consists of a consumable mixture of the proteins or a fraction of the proteins from one or a plurality of non-leguminous plants, preferably tubers or roots, and at least one aqueous extractable fraction from at least one vegetable raw material, preferably from leguminous plants, cereals, sweet grasses, pseudo grains, cannabaceae (hemp plants), nuts or edible mushrooms. The invention, moreover, relates to a method for producing such an egg substitute product and to the use of such egg substitute products.

### CROSS-REFERENCE TO RELATED APPLICATIONS

This application claims benefit of EP Application Number 22020091.9 filed Mar. 4, 2022, which is herein incorporated by reference.

### FIELD OF THE DISCLOSURE

The present disclosure relates to an egg substitute. Furthermore, the invention relates to a method for producing such an egg substitute. Furthermore, the invention relates to the use of such an egg substitute.

### BACKGROUND OF THE DISCLOSURE

Eggs are one of the most widely consumed foods worldwide and an indispensable product in the foodstuffs industry.

Eggs are important ingredients in a variety of culinary applications, including savory and sweet baking and cooking. Eggs are useful in home cooking, in the food services industry and the foodstuffs industry. They provide a wide range of important functionalities (culinary and technological functional properties) and are used, for example, as leavening agents, for retention (thickening), as foaming agents, for gelling (solidification), for water retention and for emulsification. Eggs are thus found in the various sectors and product groups of the foodstuffs industry and are used as an ingredient or functional additive or constituent in countless products. Examples include desserts and baked goods for bakeries, pastry shops and confectioneries, sauces and dressings, cooked products such as dough and potato preparations, convenience products or snacks, to name just a few.

Eggs are, moreover, a source of protein, vitamins, iron and other nutrients. The use of eggs in consumer products can often reduce the sugar and/or fat content and increase the protein content without changing the organoleptic properties.

Eggs are, however, raising more and more questions in relation to environmental, ethical, farm animal, or human health impacts, namely:
in the area of the environment, for example, often in relation to problematic feed cultivation, its origin and procurement (soy), long transport routes, low food conversion efficiency of fattening animals and the associated high water consumption and CO₂ emissions,
in the field of ethics, for example, in relation to the living conditions of laying hens, the short lifespan of laying hens (killing when laying performance decreases), the killing of male chicks, which have no commercial relevance to this industry, and the methods used for this;
in the area of livestock or human health, for example, in relation to problems caused by fipronil, salmonella, or the risk of transmission of infection from animals to humans during major outbreaks of disease (for example, H1N5).

For some or all of these reasons, consumers—especially vegans, flexitarians, vegetarians and other environmentally-conscious consumers—are looking for a sustainable alternative to eggs that is plant-based, allergen-free, low in saturated fat and contains as few as possible, or no, artificial ingredients to replace eggs in various products and cooking recipes.

For the above reasons, there is an increasing need to find an egg substitute to replace the desired nutritional, culinary and technical functional properties of chicken eggs. These properties include, but are not limited to:
gelling (thermal gelling, water holding capacity)
retention (swelling properties, thickening)
stabilization (dispersing and suspending properties)
fat-retention capacity (emulsifying properties)
foaming behavior (foam volume, foam stability).

In certain recipes, household remedies are used as egg substitutes. Examples include mashed bananas, applesauce, silken tofu or flax or chia seeds soaked in water as a substitute for eggs in baking; baking powder mixtures or the use of carbonated water (sparkling water) as a leavening agent or flour-water mixtures as a binding agent.

The disadvantage of such household remedies is that they often only replace one property of eggs. Moreover, none of them allows egg-like gelation under the effect of heat.

Legume cooking water, also known as aquafaba, has been the subject of discussion by interested groups in both literature and social media (Stantiall et al., 2018; Shim et al., 2018; Buhl, 2019; patent WO 2020/030819 A1 of Carter, 2020; Wikipedia, 2022). Efforts to standardize the composition of aquafaba have been made by various actors (patent WO 2020/030819 A1 of Carter, 2020; patent EP 3 788 885 A1 of Reaney and Mustafa, 2021). Historical evidence shows that the use of bean and pea water found application during wartime under the name “false whipped egg whites”. As the name implies, aquafaba can primarily serve as a substitute for whipped egg whites, as its primary functionality is in foaming. This functionality is already widely used, for example, with the “Oggs” product by Alternative Foods (Alternative Foods, 2022) covered by patent WO 2020/030819 A1 (Carter, 2020), by patent US 2018/303105 A1 (Desjardins-Lavisse et al., 2018) or by patent EP 3 788 885 A1 (Reaney and Mustafa, 2021). Other functionalities, such as gelation, cannot be achieved with aquafaba.

In certain recipes, powdered mixtures of starches, proteins, flours and/or fibers, often in combination with other additives such as thickeners, emulsifiers and/or colorants, are proposed as egg substitutes. These include, for example, products with components from microalgae, flaxseed or chickpea flour (patent WO 2009/021110 A1 of Elmusa et al., 2009; patent WO 2018/011786 A1 of Reifen et al., 2018; patent FR 3 110 339 A1 of Barre and Traore, 2020; patent WO 2021/176454 A1 of Lengel and Yehezkeli, 2021; patent WO 2021/116949 A1 of Noble et al., 2021). Products of this type are often powdered egg substitutes, for example, the products of Biovegan (Biovegan, 2022), the products of MyEy (MyEy, 2022), or the “Zero Egg” product from the eponymous company (Zero Egg, 2022) with patent WO 2019/220431 A1 (David, 2019). These can take over, at least to some extent, retention and thickening, and in some cases also stabilizing or foaming functions of the chicken egg in certain product groups. The range of applications and functionalities, in particular thermal gelation, are however very limited in practice and cannot completely replace the full technical functional, culinary, and nutritional properties of eggs.

Liquid egg substitutes are largely based on the same raw materials as powder substitutes, which are listed in the previous paragraphs. In order to obtain a liquid egg substitute, these base materials are typically mixed with water, one or a plurality of oils or fats, an aqueous extract, or a mixture of these components (patent WO 2019/164651 A1 of Altman and McClure, 2019; patent WO 2021/116949 A1 of Noble et al., 2021). By mixing with a suitable quantity of emulsifiers and/or proteins, an emulsion can also be formed from an aqueous phase and an oily phase, by way of example, a plant-based milk alternative as in patent WO 2020/080947 A1 (Tarazanova, 2020), which can also be mixed with the powdered ingredients. Some of these liquid egg substitutes promise better functionality but may contain controversial ingredients such as tetrasodium pyrophosphate, sodium diphosphate, sodium carboxymethylcellulose, and other additives (for example, preservatives), such as the Just Egg product from the eponymous company (Just Egg, 2022) or the VeganEgg product from Follow Your Heart (Follow Your Heart, 2022).

Although some egg substitutes are commercially available and home remedies are already used, there is still a need for an egg substitute that can achieve key technical functional, culinary, and nutritional properties while being free of artificial additives.

### SUMMARY OF THE DISCLOSURE

### Task

The present disclosure is firstly based on the task of creating an egg substitute which can replace eggs and/or their functionalities in a wide range of typical egg applications.

The present disclosure is moreover based on the task of proposing a method by means of which such egg substitutes can be produced.

Lastly, the present disclosure is based on the task of proposing uses for such egg substitutes.

### Solution of the Task Regarding a Product

Further described is a solution provided by an egg substitute for whole chicken eggs, chicken egg albumen or chicken egg yolks, consisting of a consumable mixture of the proteins or a fraction of the proteins from one or a plurality of non-leguminous plants, preferably from at least one plant and/or microbial and/or animal raw material, preferably from pseudo cereals, sweet grasses, cannabaceae, nuts, red algae, green algae, blue-green algae, roots, tubers, edible mushrooms, cow milk, insects, more preferably from sugar beets, wheat, corn, millet, rice, oats, rapeseed, flax, hemp, peanuts, hazelnuts, almonds, cashews, purple laver, chlorella or spirulina, manioc, cassava, sweet potatoes, yam, sago, taro, milk protein, insect protein or most preferably from potatoes and at least one aqueous extractable fraction from leguminous plants and/or sweet grasses and/or pseudo cereals and/or edible mushrooms, preferably soy, most preferably peas, chickpeas, yellow peas, beans, field beans, mung beans, lupines, rice, oats, spelt, buckwheat, amaranth, mushrooms, optionally with at least one added starch, optionally with at least one added fat and/or oil.

Further described is a solution of the task achieved by an egg substitute for whole chicken eggs, chicken egg albumen or chicken egg yolks, consisting of a consumable mixture of the proteins or a fraction of the proteins from one or a plurality of tubers or roots, preferably potato protein, and at least one aqueous extractable fraction from at least one vegetable raw material, preferably from leguminous plants, cereals, sweet grasses, pseudo grains, cannabaceae, nuts, edible mushrooms, more preferably peas, chickpeas, yellow peas, beans, soy, field beans, mung beans, lentils, lupines, rice, oats, wheat, spelt, buckwheat, amaranth, hemp, almonds, hazelnuts, cashew nuts, mushrooms, optionally with at least one added starch and/or flours, optionally with at least one added fat and/or oil.

### BRIEF DESCRIPTION OF THE DRAWINGS

The figures disclosed herein are not necessarily to scale and certain features may be shown exaggerated in scale or in a somewhat generalized schematic form in the interest of clarity and conciseness. For the complete understanding of the features and advantages of the present disclosure, reference is now made to the detailed description along with the accompanying figures, wherein:

FIG. 1A shows the photo of dispersions of aqueous extract of leguminous plants (6, left) and water (7, right), each dispersed with 4% potato protein isolate and 8% vegetable starch 1 minute after dispersion by stirring by hand.

FIG. 1B shows the photo of dispersions of aqueous extract of leguminous plants (6, left) and water (7, right), each dispersed with 4% potato protein isolate and 8% vegetable starch 10 minute after dispersion by stirring by hand.

FIG. 2A shows the photo of Maillard browning when using potato protein with water as egg substitute in a cheese quiche alternative with comparable recipe and identical baking process.

FIG. 2B shows the photo of Maillard browning when using the same amount of potato protein with aqueous extract from leguminous plants instead of water as egg substitute in a cheese quiche alternative with comparable recipe and identical baking process.

FIG. 2C shows the photo of Maillard browning when using potato protein with the same amount of aqueous extract from leguminous plants without potato protein with comparable dry matter as b) as egg substitute in a cheese quiche alternative with comparable recipe and identical baking process.

FIG. 3 is schematic diagram showing a process of making and using an egg substitute according to an embodiment of the present disclosure.

### DETAILED DESCRIPTION

It is already noticeable when mixing the aqueous extract with protein and optionally added starch and/or optionally added flour(s) that a significantly more stable suspension is produced than when using water instead of the aqueous extract. This is particularly advantageous for a constant consistency of the product in its application, where improved technical functional properties are shown. These properties are, for example, higher gelling capacity, especially when exposed to heat, better water retention capacity, improved foam stability after foaming by means of introduction of air; better emulsification and improved retention.

The designation “protein” or “proteins” or “protein from a raw material source” or “proteins from a raw material source” or comparable designations or analogously comparable designations generally describes/describe the entirety or a part of the entirety of the proteins occurring in this raw material source.

A significant, surprising finding was that in an exemplary embodiment of the product, by using potato protein (by way of example, at 3% to 8% [w/w]), in order to achieve a desired product hardness, the concentration of potato protein in an application example with chickpea cooking water (example of an “aquafaba”) can be chosen that is significantly lower than was the case with water.

“Aquafaba” is deemed to be an aqueous extract from leguminous plants, often called hot extract, also, for example, as a side effect of commercial sterilization. It can also be a cold extraction, and sometimes a combination, for example, by combined heating with continuous storage in cans or other containers. Depending on the extraction conditions, aquafaba often contains 20% to 35% [w/w] protein in the dry matter as well as usually more than 50% [w/w] polysaccharides (for example, starches, pectins, hemicelluloses, soluble sugars). The terms “aquafaba” and “legume water” are used interchangeably throughout this description. The abbreviation “[w/w]”, standing for “weight per weight” and denotes a percentage by weight. It corresponds to “g/100 g”, “% wt” is also occasionally used.

By using aquafaba instead of water, while ensuring comparable or more suitable product properties, protein can be saved or replaced by a by-product from the processing of leguminous plants, the products are also characterized by a significantly lower sensory note of the protein during use due to the lower concentration of the protein. In this, it is substantially irrelevant whether starch has been added to the product or not; in each case, the use of aquafaba led to a significant improvement in gel hardness.

Through the addition of native proteins and, if necessary, native starches, the product can be thermally gelatinized. It has been found that, in a preferred embodiment, the gelling temperature lies in a similar temperature window to that of eggs, preferably 50° C. to 100° C., more preferably 55° C. to 90° C., most preferably 60° C. to 85° C., so that recipes that work with egg advantageously require little or no adjustment. Thermally induced gelation of the product is irreversible. The thermally gelled product accordingly retains its gel properties even after cooling.

It turned out to be particularly surprising that by using aquafaba (for example, from chickpeas or from a mixture of chickpeas and yellow peas; dry matter 6% [w/w]) instead of water as solvent for the protein used (for example, potato protein; 4% [w/w]), the penetration resistance of a gel, preferably gelled thermally and/or by acid and/or enzymes, has been significantly increased by at least 5%, preferably by at least 10%, preferably by at least 20%, more preferably by at least 30%, more preferably by at least 40%, more preferably by at least 50%, more preferably by at least 60%, more preferably by at least 70%, more preferably by at least 80%, more preferably by at least 90%, most preferably by at least 100%, wherein the penetration resistance is measured with a commercially available texture analyzer (for example, from Stable Microsystems).

This surprising finding likewise applies to the water retention of the gels with the same mixture and with the same mass proportions. Thus, through use of aquafaba instead of water as solvent, for the same quantity of protein used, the water retention of gels, preferably gelled thermally and/or by acid and/or by enzymes, is significantly increased, by at least 10% [w/w], preferably at least 20% [w/w], more preferably at least 30% [w/w], more preferably at least 40% [w/w], more preferably at least 50% [w/w], more preferably at least 60% [w/w], more preferably at least 70% [w/w], more preferably at least 80% [w/w], more preferably at least 90% [w/w], most preferably at least 100% [w/w], wherein the water retention is determined by differential weighing before and after standardized thermal heating in an open pan. Experiments indicate, for example, that potato protein and aquafaba interact synergistically. The synergistic effect of at least two proteins or at least one protein and at least one co-polymer is well known. It is exploited in various fields of application, for example, in the cosmetic industry or in plant-based substitutes for animal foods (patent WO 2019/088834 A1 of Zhu et al., 2019). This effect had not yet been established for the field of egg substitutes.

Interestingly, the drainage rate can also be reduced for the same mixture and mass proportions in foams. Thus, the time after which 50% [w/w], of the fluid initially retained in the foam has once again separated from the foam is increased by at least 40% [w/w], more preferably by at least 60% [w/w], preferably by at least 80% [w/w], preferably by at least 100% [w/w], if the potato protein used by way of example is dispersed in aquafaba instead of in water.

With regard to foaming, the product also shows a foaming stability that is increased by at least 10%, preferably at least 20%, preferably at least 30%, preferably at least 50%, and a whipping volume increased by at least 5%, preferably at least 10%, preferably at least 20%, preferably at least 30%, preferably at least 50%, preferably at least 100%, compared to a situation in which the protein component of the mixture is foamed only in water instead of the aquafaba which could be used by way of example.

In terms of emulsification effect, the product shows higher emulsion stability and smaller droplet size distribution as well as lower coalescence compared to a situation where the emulsion is prepared from a mixture of the protein component with water instead of the aquafaba which could be used by way of example.

In some inventive embodiments, one or a plurality of coloring constituents and/or colorants and/or foodstuffs having a coloring effect may be added to the product. These may be in powder or liquid form and may be water-soluble and/or fat-soluble.

Coloring components and/or extracts preferably include natural raw materials which are one or a plurality of products from tubers, roots and vegetables, more preferably from carrots (beta carotene) and/or turmeric and/or red beets.

In some inventive embodiments, the product may contain yeast, yeast extracts, salt, black salt/sulfur salt, sugar and/or spices such as pepper or paprika and/or combinations thereof.

It should be noted, however, that the detailed description and specific examples, although described preferred embodiments of the invention are for illustrative purposes only, as various embodiments, changes and modifications within the scope of the invention and the scope of the invention will be apparent to persons skilled in the art from this detailed description.

Further described is an egg substitute in which the aqueous extractable fraction(s) is/are at least an aqueous extract of one or a plurality of raw materials or parts thereof, more preferably an aqueous extract or parts thereof of leguminous plants or components thereof, and/or sweet grasses or components thereof, and/or pseudo grains or components thereof, and/or nuts or components thereof, and/or edible mushrooms or components thereof, more preferably at least one aqueous extract or parts thereof of peas and/or chickpeas and/or yellow peas and/or field beans and/or mung beans and/or lentils and/or lupines and/or rice and/or oats and/or spelt and/or buckwheat and/or amaranth and/or mushrooms, or components thereof, most preferably aquafaba or parts thereof, prepared from peas and/or chickpeas and/or yellow peas and/or beans and/or field beans and/or mung beans and/or lentils and/or lupines, or parts thereof.

According to the invention, in some embodiments, the aqueous extractable component(s) or aqueous extractable fraction(s) of the raw material may be one or a plurality of fraction(s) of an aqueous extract.

An “aqueous extractable fraction” is understood to be one or a plurality of components of the extracted raw material which can in principle be obtained by aqueous extraction, wherein “aqueous extractable fraction” thus describes a material property.

An “aqueous extract” is understood to be the totality of the aqueous extractable fraction(s) that effectively pass(es) into the extracting agent during an aqueous extraction. In this context, not all fractions/components need to be genuinely dissolved, but rather this refers to compounds which remain in the aqueous supernatant in usual industrial separation steps (separation, for example, decantation), but which can nevertheless separate from the aqueous supernatant over time (for example, by formation of aggregates).

The raw material source may be whole, fractionated (for example, by dry fractionation), dehydrated, or fresh components of one raw material/a plurality of raw materials that may already have been pre-processed (for example, cooked, pickled, and/or fermented), depending on the use.

In some inventive embodiments, it is possible that the aqueous extraction may be preceded by a swelling process, preferably in water, of between ½ h to 40 h, more preferably 1 h to 30 h, more preferably 1½ h to 20 h, more preferably 2 h to 10 h. This process may additionally include a freezing or heating step.

In some inventive embodiments, the extraction may be preceded by wet or dry grinding of the raw material source in a cold or hot state, wherein the cold extraction proceeds at between −40° C. and 40° C., preferably at between −20° C. and 30° C., more preferably at between −5° C. and 25° C., most preferably at between 0° C. and 25° C.

The extraction can be carried out with water or another solvent such as cow milk or fractions of cow milk. In addition, salt, sodium carbonate, vinegar, lemon juice or alcohol, such as ethanol, can be added as an excipient for the extraction, which is to say, the quality of the solvent is changed by the type and concentration of salt as well as by the pH or more polar or less polar substances, and the extraction result can thus be controlled. Likewise, the extraction result is changed and controlled by a pretreatment for comminution of the raw materials (whole raw materials such as whole chickpeas, fractional raw materials in which the median of the particle size distribution is 0.3 mm to 5 mm, more preferably 0.5 mm to 3 mm, more preferably 1 mm to 2 mm, as well as ground raw materials in which the median of the particle size distribution is 20 μm to 1000 μm, preferably 30 μm to 500 μm.

If reference is made to extract or aqueous extractable fraction from a raw material, for example, to “extract from leguminous plants” or “aqueous extractable fraction from leguminous plants”, or to protein from a raw material, for example, “protein from leguminous plants”, it is always the extract or protein from parts of the raw material typically used for protein extraction and/or starch extraction and/or fat extraction, for example, the oat grain and not the oat plant as a whole, the buckwheat grain and not the buckwheat plant as a whole, the potato tuber and not, for example, the above-ground part of the potato plant or the soy seed and not the soy plant.

In the extraction of aqueous extractable fractions from raw materials (for example, leguminous plants), the extraction result, in particular the protein proportion in the extract, is controlled by means of the pH value during extraction. Preferably, the aquafaba is extracted at a pH value of 5 to 10, more preferably 5.5 to 9, more preferably 6 to 8. Independently, the pH value of the aqueous extract is adjusted to a pH value of 4.5 to 7.5, more preferably 5 to 7, still more preferably 5.5 to 6.5, before use in the mixture.

In some inventive embodiments, the proportion of dry matter derived from the aqueous extract may be 2% to 30% [w/w], more preferably 3% to 25% [w/w], most preferably 5% to 15% [w/w], of the total dry matter of the product.

In some inventive embodiments, the proportion of dry matter derived from the aqueous extract may amount to 10% to 70% [w/w], preferably 15% to 60% [w/w], preferably 15% to 50% [w/w], preferably 15% to 40% [w/w], preferably 15% to 35% [w/w], preferably 20% to 50% [w/w], preferably 20% to 35% [w/w], of the total dry matter of the product.

In some inventive embodiments, the proportion of dry matter derived from the aqueous extract may be 30% to 85% [w/w], preferably 30% to 75% [w/w], preferably 30% to 60% [w/w], preferably 30% to 50% [w/w], preferably 30% to 45% [w/w], preferably 40% to 50% [w/w], preferably 50% to 60% [w/w], preferably 35% to 75% [w/w], preferably 40% to 60% [w/w], of the total dry matter of the product.

Further described is an aqueous extraction that is a hot extraction, preferably in a temperature range of 40° C. to 121° C., more preferably 60° C. to 101° C., most preferably 80° C. to 101° C.

The consistency of the aqueous extract can be changed by the choice of temperature. At temperatures above the denaturation temperature of the proteins or protein fractions, all or part of the proteins are denatured and thus rendered at least partially insoluble in water and/or altered in their functionality. Starches may become partially or completely gelatinized. Preferably, proteins that are thermally stable and water-soluble are included, wherein the term solubility does not presuppose true solubility but rather a colloidal solubility of the proteins. The hot extraction is carried out at between 40° C. and 121° C., preferably between 60° C. and 120° C., preferably between 80° C. and 120° C., preferably between 90° C. and 110° C., preferably between 60° C. and 110° C., preferably between 40° C. and 110° C., preferably between 60° C. and 101° C., preferably between 80° C. and 101° C., preferably 90° C. and 101° C. Extraction temperatures of beyond 100° C. usually require a counterpressure. On the pressure side, extraction is carried out at overpressures of up to 1.5 bar, preferably 1.1 bar, preferably 0.85 bar, wherein this applies to both hot extraction and cold extraction.

Further described is_an egg substitute, in which the proportion of components in the aqueous extractable fraction(s) or the aqueous extract(s) exceeds 500 Da, more preferably exceeds 1 kDa, more preferably exceeds 2 kDa, more preferably exceeds 5 kDa, more preferably exceeds 10 kDa, more preferably exceeds 20 kDa, more preferably exceeds 30 kDa amounts to at least 2% [w/w], more preferably at least 5% [w/w], more preferably at least 10% [w/w], more preferably at least 20% [w/w], more preferably at least 30% [w/w], more preferably at least 40% [w/w], more preferably at least 50% [w/w], more preferably at least 60% [w/w], more preferably at least 70% [w/w], more preferably at least 80% [w/w], relative to the dry matter.

In some inventive embodiments, the aqueous extractable component/fraction or alternatively the aqueous extractable components/fractions, in particular an aqueous extract, can be additionally fractionated to achieve modified functionalities. Mechanical, physical or chemical separation can, for example, be used for fractionation. Mechanical processes include, for example, sieving, filtering, decanting, centrifuging.

Surprisingly, it has been shown that fractionation, for example, via membrane separation technology, results in fractions that exhibit different functionalities. The proportion of higher molecular weight components (for example, proteins, polysaccharides or combinations thereof) in the aqueous extract can thus be increased, resulting in the functional effect of the aqueous extract in the mixture being altered, preferably enhanced.

The technical functional properties of the extract can be adjusted by adding acidic or basic additives, for example, fruit juices, acids, alkalis, preferably lemon juice, vinegar or sodium hydrogen carbonate.

In some inventive embodiments, the pH value of the final processed aqueous extract will be in a range of 4 to 12, more preferably 5 to 10, most preferably 5 to 8.

Further described is_an egg substitute in which the dry matter proportion of the product amounts to 2% to 60% (w/w), more preferably 5% to 45% (w/w), more preferably 8% to 40% (w/w), more preferably 10% to 35% (w/w), more preferably 12% to 35% (w/w), more preferably 14% to 32% (w/w).

The product can be concentrated in wide ranges. In some inventive embodiments, the dry matter proportion of the product amounts to at least 2% [w/w], preferably at least 3% [w/w], more preferably at least 5% [w/w], more preferably at least 8% [w/w], more preferably at least 10% [w/w], more preferably at least 20% [w/w]. In some inventive embodiments, the dry matter proportion of the product amounts to at most 50% [w/w], more preferably at most 45% [w/w], more preferably at most 40% [w/w], more preferably at most 35% [w/w], more preferably at most 30% [w/w], more preferably at most 25% [w/w].

With respect to the aqueous extract, it can be adjusted to any dry matter content by removal and/or addition of a liquid component (for example, water), wherein the ranges correspond to those mentioned above for the total product. By means of removal of a part of the water contained, it may also be processed into a concentrate or powder (for example, by spray or freeze drying).

Further described is an egg substitute in which the ratio of the weight of the dry matter of the added protein(s) to the weight of the dry matter of the incorporated aqueous extractable fraction amounts to 0.05 to 5, more preferably 0.08 to 4.5, more preferably 0.09 to 4, more preferably 0.1 to 3.5, more preferably 0.1 to 3, more preferably 0.1 to 2.5, more preferably 0.1 to 2, more preferably 0.1 to 1.75, most preferably 0.15 to 1.5.

Further described is the ratio of the dry matter of the added protein to the incorporated dry matter of the added aqueous extractable fraction or the dry matter of an aqueous extract.

In some inventive embodiments, the proportion of the added protein of the non-leguminous plants to the proportion of the total dry matter of the product may amount to between 1% and 50% [w/w], more preferably between 15% and 40% [w/w], most preferably between 15% and 25% [w/w].

In some inventive embodiments, the proportion of the added protein of the non-leguminous to the proportion of the total dry matter of the product may amount to between 5% and 80% [w/w], more preferably between 10% and 60% [w/w], more preferably between 20% and 60% [w/w], more preferably between 30% and 50% [w/w].

Further described is_an egg substitute in which the proportion of non-proteins in the aqueous extractable fraction(s), based on the dry matter of the aqueous extractable fraction(s), amounts to more than 10%, more than 20%, preferably more than 30% [w/w], more preferably more than 40% [w/w], more preferably more than 50% [w/w], more preferably more than 60% [w/w], more preferably more than 70% [w/w], more preferably more than 80% [w/w].

Depending on the choice of extraction conditions, the proportion of non-protein, for example, polysaccharides such as starches, dietary fibers, soluble sugars may differ significantly. Ranges for a composition of an aqueous extract, typically extracted in a pH range of 6 to 7.5 and at 100° C. to 101° C., are:

| | |
|---|---|
| Water content: | 90% to 96% [w/w]. |
| Carbohydrates: | 2% to 5% [w/w] |
| of which sugar: | 0.5% to 2% [w/w] |
| Protein: | 0.5% to 3% [w/w] |
| Fat: | 0% to 0.5% [w/w] |

If, on the other hand, the aqueous extractable fraction of extracted and, for example, dried, partially or completely purified individual components are brought together, there is complete freedom in the composition of this part/component of the mixture.

In some of the egg substitute described herein, the proportion of protein in the aqueous extractable fraction(s), based on the dry matter of the aqueous extractable fraction(s), amounts to at most 95% [w/w], preferably at most 90% [w/w], more preferably at most 80% [w/w], more preferably at most 70% [w/w], more preferably at most 60% [w/w], more preferably at most 50% [w/w], more preferably at most 40% [w/w], more preferably at most 30% [w/w].

The gel hardness of the gelled product in some inventive embodiments may be at least 5%, preferably at least 10%, preferably at least 20%, preferably at least 30%, preferably at least 40%, preferably at least 50%, preferably at least 60%, preferably at least 80%, preferably at least 100%, preferably at least 150%, preferably at least 200% higher than the gel hardness of a comparable gel based on the protein used in the mixture alone. This surprising effect is caused at equal absolute protein amounts by the aqueous extract, indicating a synergistic effect.

The product is a “heat-set” gel, which is to say, it gels when exposed to heat and its gelation is irreversible, which is to say, it retains its solid gel structure after cooling. It is similar to a chicken egg, which can thus be replaced in various foodstuff applications and leads, for example, to better texturization and structuring of products. The gelling temperature is quantified using a DSC and a heating rate of 10° C. per minute.

According to some embodiments,_{—} the proportion of protein in the dry matter amounts to 20% to 80% [w/w], preferably 30% to 70% [w/w].

Deviating therefrom, in some embodiments, the proportion of protein in the dry matter of the product may amount to 10% to 80% [w/w], more preferably 10% to 75% [w/w], more preferably 10% to 70% [w/w], more preferably 10% to 65% [w/w], more preferably 10% to 60% [w/w], more preferably 15% to 85% [w/w], more preferably 15% to 80% [w/w], more preferably 15% to 75% [w/w], more preferably 15 to 70% [w/w], more preferably 15 to 65% [w/w], more preferably 15 to 55% [w/w], more preferably 15 to 50% [w/w], more preferably 15 to 49% [w/w], more preferably 15 to 45% [w/w], more preferably 20% to 30% [w/w], more preferably 20% to 40% [w/w], more preferably 20% to 50% [w/w], more preferably 20% to 60% [w/w].

In some inventive embodiments, the composition comprises at least 20% [w/w], at least 25% [w/w], at least 30% [w/w], at least 40% [w/w], at least 50% [w/w], at least 60% [w/w], at least 70% [w/w], or at least 80% [w/w] protein.

According to the invention, the composition of the protein can vary greatly and is mainly determined by the addition of protein originating from non-leguminous plants as well as by aqueous extractable protein from another source, wherein it is preferable that it is from an aqueous extract, again preferably aquafaba. Depending on the extraction conditions as well as on the modification of the composition brought about by the separation technology after extraction, the protein proportion in some inventive embodiments may amount to up to 80% [w/w], preferably up to 70% [w/w], preferably up to 60% [w/w], preferably up to 50% [w/w], preferably up to 40% [w/w], preferably up to 30% [w/w], of the dry matter of the product. In some embodiments, the protein proportion in the dry matter amounts to at least 5% [w/w], preferably at least 10% [w/w], preferably at least 20% [w/w], preferably at least 30% [w/w], preferably at least 40% [w/w], preferably at least 50% [w/w], preferably at least 60% [w/w], preferably at least 70% [w/w], preferably at least 80% [w/w].

The total aqueous product may in some inventive embodiments, for example, at a total dry matter of 18% [w/w], have an absolute protein content of 0.5% to 17% [w/w], preferably 1% to 15% [w/w], more preferably 1.5% to 14% [w/w], more preferably 1.8% to 12% [w/w], more preferably 1.9% to 10% [w/w], more preferably 1.9% to 9% [w/w], more preferably 1.9% to 7% [w/w], more preferably 1.9% to 6% [w/w], more preferably 1.9% to 5% [w/w] protein.

In some inventive embodiments, the dry matter may comprise at least 2% [w/w], preferably at least 5% [w/w], preferably at least 8% [w/w], preferably at least 10% [w/w], preferably at least 20% [w/w], preferably at least 25% [w/w], preferably at least 30% [w/w], preferably at least 40% [w/w], preferably at least 50% [w/w], preferably at least 60% [w/w], preferably at least 70% [w/w], preferably at least 80% [w/w] non-legume protein.

On the other hand, in some inventive embodiments, the dry matter can comprise up to 80% [w/w], preferably up to 70% [w/w], preferably up to 60% [w/w], preferably up to 50% [w/w], preferably up to 40% [w/w], preferably up to 30% [w/w], preferably up to 25% [w/w], preferably up to 20% [w/w], preferably up to 10% [w/w], preferably up to 8% [w/w], preferably up to 5% [w/w], preferably up to 2% [w/w] non-legume protein.

The proportion of protein from non-leguminous plants, for example, potato protein, in the total protein of the product, may in some inventive embodiments be from 1% to 80% [w/w], preferably 2% to 60% [w/w], preferably 3% to 40% [w/w], preferably 5% to 50% [w/w], preferably 10% to 50% [w/w], preferably 15% to 40% [w/w].

The proportion of non-legume protein, for example, potato protein, in the total product, by way of example, at a dry matter of 18% [w/w], in some inventive embodiments may be from 0.1% to 10% [w/w], preferably 1% to 10% [w/w], preferably 1% to 8% [w/w], preferably 1.5% to 8% [w/w], preferably 1.9% to 8% [w/w], most preferably 1.9% to 6% [w/w].

According to some embodiments, the mixture, relative to the dry matter, contains up to 20% [w/w], preferably up to 30% [w/w], more preferably up to 40% [w/w], more preferably up to 50% [w/w], more preferably up to 70% [w/w], more preferably up to 80% [w/w] of one or a plurality of added starches and/or one or a plurality of added flours.

In some inventive embodiments, the product may contain up to 5% [w/w], preferably up to 10% [w/w], preferably up to 20% [w/w], preferably up to 30% [w/w], preferably up to 40% [w/w], preferably up to 50% [w/w], preferably up to 70% [w/w], preferably up to 80% [w/w] of one or a plurality of added starches and/or of one or a plurality of added flours in the dry matter.

In some inventive embodiments, the proportion of one or a plurality of added starches and/or one or a plurality of added flours in the dry matter may amount to at least 80% [w/w], preferably at least 70% [w/w], preferably at least 60% [w/w], preferably at least 50% [w/w], preferably at least 40% [w/w], preferably at least 30% [w/w], preferably at least 20% [w/w], preferably at least 10% [w/w].

In some inventive embodiments, the starch content in the dry matter amounts to 10% to 80% [w/w], preferably 20% to 75% [w/w], preferably 25% to 70% [w/w], preferably 30% to 70% [w/w], preferably 40% to 60% [w/w].

Further starches and/or polysaccharides, which are introduced into the product, by example, via the aqueous extract, are added to these proportions. Starch may be used in the present invention to replace some of the protein required, for example, for gelation.

In some inventive embodiments, the total aqueous product may contain, for example, at a total dry matter of 18% [w/w], 1 to 25% [w/w], preferably 2 to 15% [w/w], preferably 3 to 15% [w/w], preferably 2 to 20% [w/w], preferably 5 to 20% [w/w], preferably 5 to 15% [w/w], preferably 10% to 20% [w/w], preferably 4 to 10% [w/w] of one or a plurality of added starches and/or one or a plurality of starch-containing flours.

Further described is an egg substitute in which the mixture contains one or a plurality of added starch(es) and/or flour(s) which are one or a plurality of products from pseudo cereals, sweet grasses, vegetables, leguminous plants, tubers, roots, rosales or nuts preferably from millet, oats, rapeseed, spelt, buckwheat, amaranth, sugar beets, peas, yellow peas, beans, soy, cassava, sweet potatoes, yam, sago, taro, kudzu, hemp, hazelnuts, most preferably from corn, wheat, spelt, rice, chickpeas, field beans, mung beans, lentils, lupines, potatoes, manioc, arrowroot, flax, psyllium, almonds, cashew nut, or a combination thereof.

In some inventive embodiments, the product may include one or a plurality of added starch(es) and/or flour(s) that are one or a plurality of products of pseudo grains, sweet grasses, vegetables, leguminous plants, tubers, roots or rose-like preferably from beans, peas, chickpeas, soy, cassava, sweet potatoes, yam, sago, taro, kudzu, most preferably corn, wheat, potatoes, manioc, arrowroot, flax, psyllium, or a combination thereof. The starch or starch-containing flours may be modified and/or unmodified and/or native starches.

The added starch or starch-containing flour may serve to, among other things, modify one or a plurality of technical functional properties such as gelation, water retention, foamability and foam stability, emulsifying capacity and emulsion stability, and/or replace protein in the blend without substantially changing the technical functional properties. For example, by adding a starch, such as a vegetable starch, the amount of protein required to achieve comparable technical functional properties can be reduced, which represents a financial advantage.

The product can have one or a plurality of swellable hydrocolloids added to it, if necessary. These can serve, among other things, for the purpose of water retention and/or optimization of texturing and/or stabilization and/or swelling and/or thickening and/or thickening and/or thermal stabilization. The swellable hydrocolloids can, for example, in the case of a total aqueous product, with a dry matter of 18% [w/w] amount to 0.1% to 5% [w/w], more preferably 0.3% to 4% [w/w], still more preferably 0.5% to 3% [w/w], of the mixture. Hydrocolloids are preferably derived from animal or vegetable raw materials, such as psyllium and/or flaxseed and/or guar and/or carob and/or fibers and/or pentosans, but may also be produced by biotechnology or fermentation. The dietary fibers used are preferably from wheat, rye, oats, corn, peas, beans, potatoes, flax, acacia, inulin, carrots, apples. Gelling agents such as agar, pectin, gellan gum may also be added to the product.

In some inventive embodiments, the total aqueous product may contain, for example, in the case of a total dry matter of 18% [w/w], 0.1% to 10% [w/w], preferably 0.1% to 5% [w/w], preferably 0.1 to 4% [w/w], preferably 0.5% to 4% [w/w], preferably 0.5% to 3% [w/w] of dietary fiber.

One or a plurality of emulsifiers from animal or vegetable sources may be added to the product to improve the emulsifying properties of the product, preferably from leguminous plants, sweet grasses, seeds and nuts or whey, more preferably from soy, sunflower, rapeseed, peanuts or corn, for example, soy lecithin, sunflower lecithin, saponins, phospholipids.

Further described is an egg substitute in which fat and/or oil is added to the egg substitute and/or the aqueous extractable fraction(s) and/or the aqueous extract(s) and amounts to up to 80% (w/w), more preferably up to 65% (w/w), more preferably up to 60% (w/w), more preferably up to 55% (w/w), more preferably up to 50% (w/w), more preferably up to 44% (w/w), more preferably up to 40% (w/w) of the dry matter.

In some inventive embodiments, fat and/or oil may be emulsified in the aqueous extractable component or product. The terms “fat” and “oil” are used synonymously throughout the description. The oil proportion in the dry matter may be up to 80% [w/w], preferably up to 60% [w/w], preferably up to 50% [w/w], preferably up to 40% [w/w], preferably up to 35% [w/w], preferably up to 30% [w/w], preferably up to 25% [w/w], preferably up to 20% [w/w], preferably up to 15% [w/w], preferably up to 10% [w/w], preferably up to 5% [w/w].

In some inventive embodiments, the amount of fat in the dry matter of the product amounts to at least 1%, preferably at least 2%, preferably at least 5%, preferably at least 10%, preferably at least 20%, preferably at least 30%, preferably at least 40%, preferably at least 50%, preferably at least 60%, preferably at least 70%, preferably at least 80%, preferably at least 90%. Additionally, by increasing or decreasing the pH value when emulsifying the fat or/and oil, for example, with vinegar, the emulsifying capacity of the product can be changed.

In an exemplary embodiment, in the case of a dry matter of the total product of 18% [w/w], the quantity of oil contained in the product amounts to 0.5% to 10% [w/w], preferably 1% to 8% [w/w], preferably 2% to 6% [w/w], preferably 3% to 5% [w/w].

In some inventive embodiments, the aqueous extractable component/fraction may contain emulsified fat or oil proportions and is thus comparable in composition to a product that is similar to cow milk or similar to plant milk (colloquially called plant milk or non-dairy milk, vegetable cream or plant cream). For this purpose, non-animal fats, preferably vegetable fats, are added to the aqueous extract and emulsified together with the aqueous extract. In some inventive embodiments, the fat and/or oil may also be added to the already mixed product.

The added fat(s) and/or oil(s) may be vegetable and/or animal fats and/or oils. Oils from flax, walnuts, pistachios, olives, rapeseed, pumpkin seeds, coconuts, sunflowers, thistle, avocado, clarified butter as well as milk fat are preferred.

Examples of applications in which the emulsifying properties of chicken eggs are decisive, as egg or albumen or whole egg alternatives, are in applications of hot or cold sauces or creams, preferably mayonnaises, salad dressings, dressings, vinaigrettes, garnishing sauces, dessert creams, etc.

Further described is an egg substitute in which the protein is protein-containing flour, preferably a protein concentrate, more preferably a protein isolate.

In some inventive embodiments, the protein used may be protein isolate, protein concentrate, or a protein-containing flour, or a protein-containing powder, or a protein present or dissolved in liquid form.

In some inventive embodiments, the protein may be native.

In some inventive embodiments, at least one of the added proteins may be thermally fixable, preferably at 50° C. to 100° C., more preferably at 55° C. to 90° C., more preferably at 55° C. to 80° C., more preferably at 55° C. to 75° C., most preferably at 60° C. to 70° C.

Further described is_an egg substitute in which the egg substitute thermally solidifies, wherein the temperature range is 50° C. to 121° C., 55° C. to 100° C., more preferably between 58° C. to 99° C., most preferably between 60° C. to 90° C.

According to some embodiments, the proportion of added legume protein and/or added legume flour in the total protein proportion in the dry matter amounts to at most 90% (w/w), preferably at most 80% (w/w), preferably at most 70% (w/w), preferably at most 60% (w/w), preferably at most 50% (w/w), preferably at most 40% (w/w), preferably at most 35% (w/w), preferably at most 25% (w/w), preferably at most 15% (w/w).

In some embodiments, the egg substitute may contain, relative to the dry matter, at least 10% [w/w], preferably at least 20% [w/w], preferably at least 40% [w/w], preferably at least 60% [w/w], preferably at least 70% [w/w], preferably at least 75% [w/w], preferably at least 80% [w/w], preferably at least 90% [w/w] added protein from leguminous plants.

The product may, for example, in the case of a dry matter of 18% [w/w], contain legume protein in some inventive embodiments from 1% to 15%, more preferably from 2% to 10%, most preferably from 2.5% to 6%.

In some embodiments, the egg substitute may contain, relative to the dry matter, at least 10% [w/w], more preferably at least 40% [w/w], more preferably at least 60% [w/w], more preferably at least 70% [w/w], more preferably at least 75% [w/w], more preferably at least 80% [w/w], most preferably at least 90% [w/w] of legume protein or portions thereof.

On the other hand, in some embodiments, the egg substitute may contain, relative to the dry matter, up to 90% [w/w], more preferably up to 80% [w/w], more preferably up to 75% [w/w], more preferably up to 70% [w/w], more preferably up to 60% [w/w], more preferably up to 50% [w/w], more preferably up to 40% [w/w], more preferably up to 30% [w/w], more preferably up to 20% [w/w], more preferably up to 10% [w/w] of leguminous plants or parts thereof.

In some inventive embodiments, the proportion of leguminous plants or parts thereof in the aqueous extractable fraction(s), based on the dry matter of the aqueous extractable fraction(s), may amount to at least 10% [w/w], preferably at least 20% [w/w], preferably at least 40% [w/w], preferably at least 60% [w/w], preferably at least 80% [w/w], preferably at least 90% [w/w], preferably at least 95% [w/w], most preferably at least 97% [w/w].

The product, at an exemplary dry matter of 18% [w/w], may contain in some inventive embodiments 0.1% to 5% [w/w], more preferably 0.3% to 5% [w/w], more preferably 0.5% to 4% [w/w], still more preferably 1% to 3% [w/w] of one or a plurality of swellable hydrocolloids, preferably psyllium, flaxseed or exopolysaccharides from microorganisms.

Further described is an egg substitute, which before use, consists of two components stored separately from each other, wherein at least one component is present in dehydrated state.

In some inventive embodiments, the product may be present as a mixture. After the mixing process, the product may be pasteurized or sterilized in high, medium or preferably low temperature ranges, more preferably between 50° C. to 90° C., more preferably between 52° C. to 85° C., more preferably between 53° C. to 75° C., more preferably between 54° C. to 70° C., most preferably between 55° C. to 65° C. Preservation by high-pressure pasteurization is also possible. The product can subsequently be filled into heat-resistant containers.

### Solution of the Task Relating to the Method

In some embodiments, the task is solved by mixing a part of the mixture consisting of at least one aqueous extractable fraction of a raw material, optionally with added and emulsified fat and/or oil, together with a further component consisting of at least one non-legume protein and optionally of at least one added flour(s) and/or added starch(es).

In one step, the powder components and the aqueous extractable component are mixed, wherein the powder component is at least partially dispersed to form a relatively homogeneous suspension or a solution. With increased standing time, thickening of the suspension occurs. Further use is either directly after the mixing process or after re-mixing the dispersion as an egg substitute. The dispersion can also be further stabilized, which makes renewed mixing redundant.

### Solution of the Task Relating to Use

In some embodiments, the egg substitute disclosed herein can be used as gelling agent and/or binding agent in chicken-egg-free or chicken-egg-reduced cooked or baked products, more preferably scrambled eggs, omelets, quiches, tarts, soufflés, pasta products, breadcrumb coatings, sauces, creams, puddings, tiramisu, desserts, curds, pancakes, cakes, sponge cakes, muffins, meat alternatives, burger patties or comparable products.

Instead of in chicken-egg-free or chicken-egg-reduced cooked and baked products, the product can also be used as a cow milk substitute, butter substitute or cream substitute in cow-milk-free or cow-milk-reduced cooked and baked products. The product can also be used as a substitute for drinking milk.

### Further Embodiments

According to some embodiments, the egg substitute disclosed herein is used in foams or gas-containing, chicken-egg-free or chicken-egg-reduced cooked or baked products, preferably meringues, macaroons, cakes, muffins, sponge cakes, brioches, vegan whipped egg whites, marshmallows, chocolate marshmallows or comparable products, preferably produced thermally and/or mechanically and preferably fixed thermally and/or by mechanically induced gelling.

In some embodiments, the product disclosed herein is used as a stabilizer of emulsions, preferably as a stabilizer in mayonnaise, ice cream, edible ice, soft ice cream, sausage products, salad dressings, remoulades or comparable products.

Instead of as a substitute for whole chicken eggs, chicken egg albumen or chicken egg yolks, the product may, in some inventive embodiments, be used as a substitute for cow milk and/or cow milk products and/or products made therefrom.

### EXAMPLES

### Example 1: Production of the Aqueous Extract from Dried Leguminous Plants, Mixing Process With the Protein Component and Production of the Invention as Ready-To-Use Dispersion

In this example, a mixture of dried leguminous plants are swollen in water for 4 h to 16 h to produce the extract. Then, the swollen solids are fractionated through a 5000 μm sieve and extracted with fresh water for 60 min to 120 min at 80° C. to 100° C. Hot extraction dissolves desired functional components in the boiling water.

The protein content in the extract depends significantly on the choice of pH value during extraction. In this manner, considerably more proteins go into solution when the pH value is set above 8. In order to increase the ratio of protein to non-protein in the dry matter of the extract, a pH value range of 7.5 to 11, more preferably, 8 to 10, more preferably 8.5 to 10, still more preferably 9 to 10 is used. To obtain aquafaba, a pH value range of 4 to 10, more preferably 5 to 9, preferably 6 to 8, more preferably 6.5 to 8, more preferably 6.5 to 7.5 is chosen. Depending on the pH conditions, degree of grinding and raw material source, a composition can be obtained that in terms of protein, fat and carbohydrates corresponds to that of a commercial plant-based milk, plant-based milk substitute. In this respect, commercial milk products can also be used as an aqueous extract or alternatively based on the dry matter as an aqueous extractable fraction.

After skimming off the cooked leguminous plants, the liquid extract can be fractionated with a filter having a mesh size of preferably 200 μm to 1000 more preferably 200 μm to 800 more preferably 250 μm to 600 most preferably 300 μm to 500 μm.

The extract is standardized to a concentration of 3° Bx to 10° Bx by the addition of water. Subsequently, the pH value of the extract is lowered to the desired range of 4 to 9 by the addition of acid or a component with a lower pH value. The extract is subjected to a pasteurization or sterilization step during or after filling for preservation.

The powdered non-legume protein is then mixed—in this example together with the starch component. Optionally, a fat or oil component can also be added.

### Example 2: Dispersion Stability

The invention represents a dispersion. The particles contained in the solvent are more stable than in a dispersion containing only the aqueous extractable component or only the protein and possibly starch component together with water.

The invention in the embodiment of a mixture of 4% potato protein isolate in combination with 8% vegetable starch dissolved in aqueous extract from leguminous plants shows a better dispersion than in the same concentration in water with identical mixing methodology.

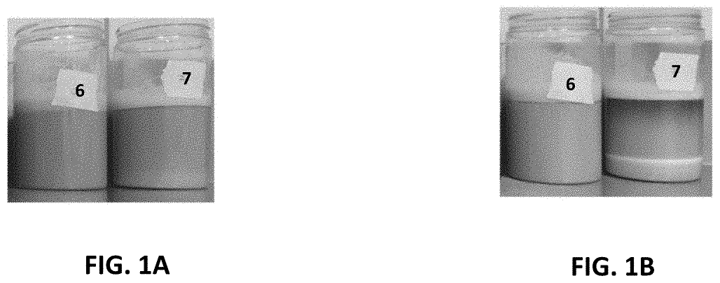

Ten minutes after dispersion by hand stirring, the weaker dispersion stability of the mixture with water due to sedimentation becomes evident, whereas the mixture with aqueous extract of leguminous plants does not show such sedimentation, as can be seen in FIGS. 1A and 1B.

Specifically, dispersions of aqueous extract of leguminous plants (6, left) and water (7, right), each dispersed with 4% potato protein isolate and 8% vegetable starch 1 minute and 10 minutes after dispersion by stirring by hand are shown in FIG. 1A and 1B, respectively.

Even over periods of 30 minutes and 60 minutes, the dispersion of the invention remains stable in contrast to the dispersion with protein-starch-component and water.

### Example 3: Foam Stability

Through the use of the invention, more stable foams can be produced than when using one single component of the invention with water, for example, in combination with the same protein and water, or using the aqueous extract alone without added protein proportion. In addition, the foam stability can be further increased when starch is used, wherein a more stable foam is developed using the invention than using water in the same combination.

The time required for 50% of the fluid initially retained in the foam to be separated from the foam may, in some inventive embodiments, be extended by at least 40%, preferably by at least 60%, most preferably by at least 100% in the foamed product compared to the stability of a foam prepared using a single component of the invention with water, for example, in combination with the same protein and water, or using the aqueous extract alone without added protein.

This finding was corroborated in a replicable experiment.

The invention in the embodiment of 4% potato protein, legume water as well as starch shows better foam stability than reference dispersions. The results show up to 20-fold higher foam stability as well as a 2-fold higher foam stability than reference dispersions.

The methodology used, saw 50 ml of each dispersion being foamed in the Kruss Dynamic Foam Analyzer by the introduction of air and the measurement of the “drainage half life time” (foam liquid stability in relation to 50% of the initial value) was determined over a period of 30 minutes (1800 seconds) for each sample. The “drainage half life time” was transformed into relative values as a percentage of the total observation time of 1800 seconds to quantify the foam stability as a percentage. The results are shown in Table 1.

TABLE 1
Foam stability of different dispersed systems. Measured
with Krüss Dynamic Foam Analyzer; CY4571 prismatic
column 40 mm; FL4551 filter paper 12 μm to 25 μm,
Ø 32 mm; observation time 30 minutes/1800 seconds.

| | | Foam stability |
|---|---|---|
| | Drainage | (proportion drainage |
| | half life | half life time of |
| Variant | time [s] | observation time) [%]. |
| aqueous extract from leguminous | 470.2 | 26.12 |
| plants | | |
| 4% potato protein in water: | 91.5 | 5.08 |
| 4% potato protein in aqueous | 945.1 | 52.51 |
| extract from leguminous plants: | | |
| 4% potato protein + 8% starch | 772.5 | 42.92 |
| in water | | |
| 4% potato protein + 8% starch in | >1800 | >100 |
| aqueous extract of leguminous | | |
| plants | | |

### Example 4: Gel Hardness

One of the key properties of egg substitutes is gelation. Gel-forming material systems are used in the foodstuffs industry in a variety of ways, including stabilization and retention of different food matrices, for example, in baked goods.

Gels generally consist of three-dimensionally crosslinked polymer chains in an aqueous medium, with the aqueous medium being enclosed in the interstices of the dispersed polymer network.

A distinction is made between cold-set gels, which are formed from a hot liquid dispersion on cooling, and heat-set gels, which gel only on exposure to heat.

The gelation process can be reversible or irreversible, depending on whether the gel structure is retained by renewed heating or cooling or whether the gel liquefies again. Among other things, gels differ in terms of their hardness, elasticity and water-retention capacity.

The invention in the embodiment of aqueous extract from leguminous plants in combination with potato protein and starch components resulted in higher hardness in terms of gel formation than reference dispersions. A 5 to 80-fold improvement over the reference dispersions was observed.

The methodology used saw 60 g each of the liquid dispersions being heated in standardized silicone molds in an oven at 150° C. for 25 minutes and then cooled to room temperature. The starch proportion used was a combination of cornstarch and tapioca starch, always in the same ratio.

The corresponding measured values are listed in Table 2 and can be quantitatively verified.

The dispersed systems thermally gelled in this way, as well as whole egg in the reference, were analyzed with respect to structural hardness by means of a texture analyzer.

TABLE 2
Texture analysis of different dispersed systems. Measuring instrument
and parameters: Texture Analyzer TA HD Plus, Stable Micro Systems;
10 mm cylindrical probe, test speed: 0.5 mm/s; strain: 20%.
Mean values from quadruple determination.

| | | Hardness |
|---|---|---|
| | Hardness | (% of whole |
| Variant | absolute [g] | chicken eggs) |
| 4% potato protein in water: | 0.9 | 0.3 |
| 4% potato protein in aqueous extract | 15 | 4.6 |
| from leguminous plants: | | |
| 12% potato protein in water | 287.8 | 87.8 |
| 12% potato protein in aqueous extract | 309.0 | 94.3 |
| from leguminous plants | | |
| 4% potato protein + 8% starch in water | 68.4 | 20.9 |
| 4% potato protein + 8% starch in | 105.9 | 32.2 |
| aqueous extract of leguminous plants | | |
| Whole chicken egg | 327.7 | 100.0 |

The reference dispersions with lower protein content yield a flat, poorly gelled, watery, unstable and not cut-resistant gel as well as plenty of unretained liquid.

The invention yields a cuttable, dimensionally stable gel with significantly less water leakage. A further embodiment of the invention with higher protein concentration also allows the protein-water mixture to gel completely without unretained water.

The reference dispersion in the form of pure aqueous extract from leguminous plants showed no gelling effect in tests (remained liquid), which is why the disproportionately higher hardness and water retention of the combination of aqueous extract and protein component, compared to water and the same amount of vegetable protein, is due to the synergistic effect between the two components, which is, among other things, the object of the invention.

### Example 5: Water Retention

Gels formed from the product, for example, by thermal gelation, can retain more water than gels consisting of only one of the two components and not the combination of both.

The water retention of the gelled product in some inventive embodiments may be improved by at least 20%, preferably at least 30%, more preferably at least 40%, still more preferably at least 50%, most preferably at least 60%, compared to the water retention of a comparable gel based on the protein used in the mixture alone.

The invention in the embodiment of aqueous extract from leguminous plants in combination with potato protein and starch components resulted in better water retention than reference dispersions.

In this test, the invention was compared to individual components with water as the reference dispersion, sometimes in combination with vegetable starch.

The method used saw 30 g of liquid dispersion being heated in a pan greased with neutral vegetable oil at a uniform temperature for 2 minutes >100° C. and the result was weighed immediately afterwards in order to determine the water loss or the water retention capacity of the thermally gelled dispersed systems, as well as whole egg by way of comparison. The corresponding measured values are listed in Table 3.

TABLE 3
Measured water loss of different dispersed systems after
standardized 2-minute heating of 30 g sample material.

| | Weight | |
|---|---|---|
| | after heating | Water loss by |
| | proportional to | standardized |
| | weight before | 2-minute |
| Variant | heating: [%]: | heating [%]: |
| 4% protein in water: | 27 | 73 |
| 4% protein in aqueous extract from | 53 | 47 |
| leguminous plants: | | |
| 12% protein in water | 71 | 29 |
| 12% protein in aqueous extract from | 83 | 17 |
| leguminous plants. | | |
| 4% protein + 8% starch in water | 67 | 33 |
| 4% protein + 8% starch in aqueous | 70 | 30 |
| extract from leguminous plants. | | |
| Whole chicken eggs | 87 | 13 |

Using the invention in the form of 4% potato protein in combination with aqueous extract from leguminous plants, a 26 percentage point lower water loss was measured than with the reference dispersion.

Using 12% potato protein in combination with aqueous extract from leguminous plants, a water loss that was 12 percentage points lower than that of the reference dispersion was measured.

Using 4% potato protein and 8% starch in combination with aqueous extract from leguminous plants, water loss was 3 percentage points lower than with the reference dispersion.

Accordingly, the water retention capacity of the invention is higher in all tested variants than in comparable dispersions of only one of the two components of the invention. This functional property is relevant, for example, for scrambled egg applications.

### Example 6: Application Example Egg-Free Quiche

The hot-gelling effect of the invention was tested in chicken-egg-free glazing for tarts and quiches and showed a clear stabilizing effect compared to the reference dispersion (combination of protein component and water) and represented a good alternative to the same glazing using whole chicken eggs.

The best sensory and textural result was obtained by the invention in the embodiment consisting of a combination of aqueous extract of leguminous plants, potato protein and vegetable starch.

Among other things, but especially when used in a purely vegetable mini-cheese quiche alternative, a difference was also evident with respect to Maillard browning, as shown below.

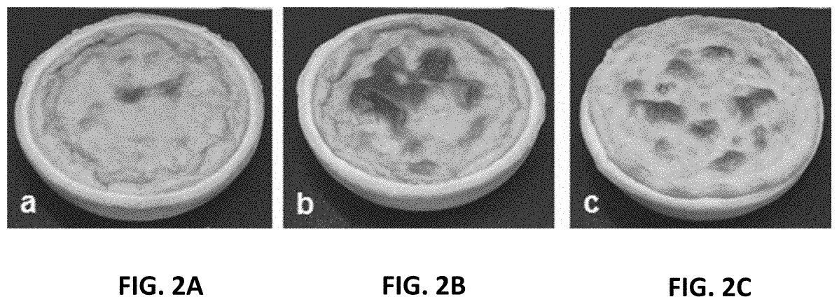

With identical baking process, the invention resulted in a stronger Maillard browning than reference dispersions with respectively only one of the components of the invention, as shown in FIGS. 2A-2C.

Specifically, Maillard browning when using different egg substitute variants in a cheese quiche alternative with comparable recipe and identical baking process: a) potato protein with water; b) the same amount of potato protein with aqueous extract from leguminous plants instead of water; c) the same amount of aqueous extract from leguminous plants without potato protein with comparable dry matter as b) are shown in FIG. 2A, FIG. 2B, and FIG. 2C, respectively.

### Example 7: Application Example Sponge Cake

The invention was tested in a simple recipe and showed a significant stabilizing effect when compared to reference dispersions and represents a good alternative to the same cake using whole chicken eggs.

The cakes were blind tasted and sensory evaluated by a panel of three experts in the field of baked goods. In the overall assessment, the invention performed best compared to the reference dispersions and whole chicken eggs and thus delivered a better result in terms of taste and texture than the other variants:
egg
water (zero variant)
aqueous extract from leguminous plants
water+potato protein
aqueous extract of leguminous plants+potato protein
water+potato protein+starch

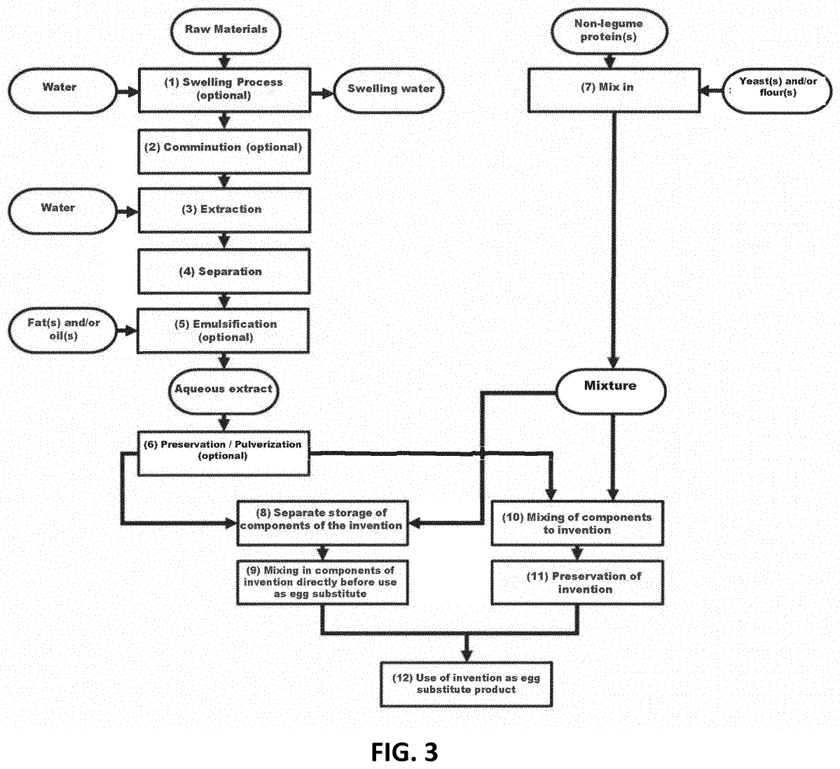

The present disclosure is described—partly schematically—in FIG. 3, with reference to an exemplary method.

In a first method step, one or a plurality of raw materials are fed to a swelling device 1, where they are swollen, in order to obtain an aqueous extractable fraction, for example, from leguminous plants and/or sweet grasses.

In the embodiment shown, dried peas, for example, are fed to the swelling device 1 as raw material. The feeding can take place batchwise, which is to say discontinuously, for example, via a silo not shown or by a mobile metering device. It is, however, also possible to feed the raw material or raw materials to the swelling device 1 by a motor-driven continuous conveyor, for example, by a conveyor belt.

In the illustrated method, the raw material or raw materials, for example, peas, have been mixed with water in a ratio [w/w] of 1:2 or 1:4, preferably 1:3, to absorb water for a defined time, for example, four hours in the illustrated embodiment. Subsequently, the swollen peas or the like are separated from the excess water not absorbed by the raw material, in the case in point peas, the so-called swelling water. The swelling water is then disposed of.

In the method described, comminution then takes place in a comminution device 2. In the method described, peas and/or oats were used, for example, which were comminuted to 500 micrometers in the comminution device 2.

Subsequently, an extraction takes place in an extraction device 3.

Raw materials, for example, peas and/or oats, are mixed with water in a swelling device 1 in a ratio of 1:1, 1:2 or 1:3 and then the pre-swollen raw materials, for example, peas and/or oats, are fed to a comminution device 2, where the pre-swollen raw materials are comminuted, which can be done by motor-driven blades, for example, Stephan mixers.

Depending on the starting materials, for example, peas and/or oats, the comminuted and pre-swollen raw materials are fed to an extraction device 3, where they are extracted at a pressure of 1 to 1.8 bar. The extraction time is adjusted according to the raw material used and is, for example, 120 minutes when peas and/or oats are used.

A separation into soluble and insoluble components of the raw materials takes place in a separation device 4, wherein technical functional properties such as retention, swelling properties, thickening, gelling, such as thermal gelling, water holding capacity, stabilization, dispersing and suspending capacity, fat retention capacity, emulsifying capacity and/or foaming behavior, foam volume, foam stability are changed depending on the starting material. For this purpose, for example, mechanical, physical or chemical separation, such as filtration or decantation, can be used. In the case of decanting, this takes place in a centrifuge.

In the embodiment shown, the peas, oats or the like used as raw material are first separated in a separation device 4 with an 800 micrometer filter and then, for example, in a second 300 micrometer filter. Separation leads to improved technical functional properties, for example, in the method described, to increased foam volume and foam stability. When using oats, separation is carried out with a 200 micrometer filter, for example, or alternatively decanted.

2% to 10% fat or oil, for example, rapeseed, sunflower or pumpkin seed oil, is added to the aqueous extractable reaction, for example, from peas and/or oats, and emulsified in an emulsifying device 5.

The first component, which is an aqueous extract of, for example, peas and/or oats, is subjected to a drying in a preservation device 6 in the method described. This can be varied depending on the recipe and raw materials used. If—as in the embodiment shown—peas are used as raw material, this preservation can be carried out at 90° C. for 30 minutes by pasteurization. A sterilization or preservation by means of high-pressure pasteurization or pulverization, for example, by spray or freeze drying, is also conceivable.

As can be seen from the drawing, the second component of the embodiment shown is mixed with a non-legume protein or a fraction of a non-legume protein, for example, from potato, depending on the desired method, optionally together with one or a plurality of starches and/or starch-containing flours, for example, cornstarch, in a ratio of 1:1 or, for example, 1:2, which takes place in a mixing device 7.

The two components, the aqueous extract and the mixture of non-legume protein and starch, can now be stored separately at the respective specified storage conditions until use, which storage takes place in a storage device 8. In the case of a pasteurized aqueous extract from peas, the storage temperature is ≤4° C.; in the case of the mixture of non-legume protein and starch, for example, this is done in a dry atmosphere at 15° C. to 25° C.

Immediately before use as an egg substitute, both components are mixed by the user in a ratio of 8:1 or 7:1 or 6:1 or 5:1 or 4:1 or 3:1, which is done in a mixing device 9. As already described, in the present example the first component consists of an aqueous extract of peas and/or oats and the second component consists of a mixture of non-legume protein with or without starch, for example, potato protein and/or corn starch.

In the method shown, the mixed product is used as an egg substitute, for example, for making a chicken-egg-free quiche, which is done at 12.

In the method according to the invention, a product is produced which contains the two previously described components, which is to say an aqueous extract and non-legume proteins, with starch, for example, being added to the mixture, although this is not absolutely necessary. Mixing takes place at 10.

The preservation step takes place in a device 11, for example—as described above—by means of high-pressure pasteurization.

Subsequently, the product is used as an egg substitute or as a milk substitute at 12.

The features described in the claims and in the description, as well as those shown in the drawing, can be critical for the realization of the invention both individually and in any combination.

1. Egg substitute for whole chicken eggs, chicken egg albumen or chicken egg yolks, consisting of a consumable mixture of the proteins or a fraction of the proteins from one or a plurality of non-leguminous plants, preferably from at least one vegetable and/or microbial and/or animal raw material, preferably from pseudo grains, sweet grasses, cannabaceae, nuts, red algae, green algae, blue-green algae, roots, tubers, edible mushrooms, cow milk, insects, more preferably from sugar beets, wheat, corn, millet, rice, oats, rapeseed, flax, hemp, peanuts, hazelnuts, almonds, cashews, purple laver, chlorella or spirulina, manioc, cassava, sweet potatoes, yam, sago, taro, milk protein, insect protein or most preferably from potatoes and at least one aqueous extractable fraction from leguminous plants and/or sweet grasses and/or pseudo grains and/or edible mushrooms, preferably soy, most preferably peas, chickpeas, yellow peas, beans, field beans, mung beans, lupines, rice, oats, spelt, buckwheat, amaranth, mushrooms, optionally with at least one added starch, optionally with at least one added fat and/or oil.

2. Egg substitute for whole chicken eggs, chicken egg albumen or chicken egg yolks, consisting of a consumable mixture of the proteins or a fraction of the proteins from one or a plurality of tubers or roots, preferably potato protein, and at least one aqueous extractable fraction from at least one vegetable raw material, preferably from leguminous plants, cereals, sweet grasses, pseudo grains, cannabaceae, nuts, edible mushrooms, more preferably peas, chickpeas, yellow peas, beans, soy, field beans, mung beans, lentils, lupines, rice, oats, wheat, spelt, buckwheat, amaranth, hemp, almonds, hazelnuts, cashew nuts, mushrooms, optionally with at least one added starch and/or flours, optionally with at least one added fat and/or oil.

3. The egg substitute of claim 1, wherein the aqueous extractable fraction(s) is/are at least an aqueous extract of one or a plurality of raw materials or parts thereof, more preferably an aqueous extract or parts thereof of leguminous plants or components thereof, and/or sweet grasses or components thereof, and/or pseudo grains or components thereof, and/or nuts or components thereof, and/or edible mushrooms or components thereof, more preferably at least one aqueous extract or parts thereof of peas and/or chickpeas and/or yellow peas and/or field beans and/or mung beans and/or lentils and/or lupines and/or rice and/or oats and/or spelt and/or buckwheat and/or amaranth and/or mushrooms, or components thereof, most preferably aquafaba or parts thereof, prepared from peas and/or chickpeas and/or yellow peas and/or beans and/or field beans and/or mung beans and/or lentils and/or lupines, or parts thereof.

4. The egg substitute of claim 1, wherein the aqueous extraction is a hot extraction, preferably in a temperature range of 40° C. to 121° C., more preferably 60° C. to 101° C., most preferably 80° C. to 101° C.

5. The egg substitute of claim 1, wherein the proportion of components in the aqueous extractable fraction(s) or the aqueous extract(s) exceeds 500 Da, more preferably exceeds 1 kDa, more preferably exceeds 2 kDa, more preferably exceeds 5 kDa, more preferably exceeds 10 kDa, more preferably exceeds 20 kDa, more preferably exceeds 30 kDa, and relative to the dry matter amounts to at least 2% [w/w], more preferably at least 5% [w/w], more preferably at least 10% [w/w], more preferably at least 20% [w/w], more preferably at least 30% [w/w], more preferably at least 40% [w/w], more preferably at least 50% [w/w], more preferably at least 60% [w/w], more preferably at least 70% [w/w], more preferably at least 80% [w/w].

6. The egg substitute of claim 1, wherein the dry matter proportion of the product amounts to 2% to 60% (w/w), more preferably 5% to 45% (w/w), more preferably 8% to 40% (w/w), more preferably 10% to 35% (w/w), more preferably 12% to 35% (w/w), more preferably 14% to 32% (w/w).

7. The egg substitute of claim 1, wherein the ratio of the weight of the dry matter of the added protein(s) to the weight of the dry matter of the incorporated aqueous extractable fraction amounts to 0.05 to 5, more preferably 0.08 to 4.5, more preferably 0.09 to 4, more preferably 0.1 to 3.5, more preferably 0.1 to 3, more preferably 0.1 to 2.5, more preferably 0.1 to 2, more preferably 0.1 to 1.75, most preferably 0.15 to 1.5.

8. The egg substitute of claim 1, wherein the proportion of non-proteins in the aqueous extractable fraction(s), based on the dry matter of the aqueous extractable fraction(s), amounts to more than 10% (w/w), more than 20% (w/w), preferably more than 30% (w/w), more preferably more than 40% (w/w), more preferably more than 50% (w/w), more preferably more than 60% (w/w), more preferably more than 70% (w/w), more preferably more than 80% (w/w).

9. The egg substitute of claim 1, wherein the proportion of protein in the aqueous extractable fraction(s), based on the dry matter of the aqueous extractable fraction(s), amounts to at most 95% (w/w), preferably at most 90% (w/w), more preferably at most 80% (w/w), more preferably at most 70% (w/w), more preferably at most 60% (w/w), more preferably at most 50% (w/w), more preferably at most 40% (w/w), more preferably at most 30% (w/w).

10. The egg substitute of claim 1, wherein the proportion of protein in the dry matter amounts to 20% to 80% (w/w), preferably 30% to 70% (w/w).

11. The egg substitute of claim 1, wherein the mixture, relative to the dry matter, contains up to 20% (w/w), preferably up to 30% (w/w), more preferably up to 40% (w/w), more preferably up to 50% (w/w), more preferably up to 70% (w/w), more preferably up to 80% (w/w) of one or a plurality of added starches and/or one or a plurality of added flours.

12. The egg substitute of claim 1, wherein the mixture contains one or a plurality of added starch(es) and/or flour(s) which are one or more products from pseudo cereals, sweet grasses, vegetables, leguminous plants, tubers, roots, rosales or nuts preferably from millet, oats, rapeseed, spelt, buckwheat, amaranth, sugar beets, peas, yellow peas, beans, soy, cassava, sweet potatoes, yams, sago, taro, kudzu, hemp, hazelnuts, most preferably from corn, wheat, spelt, rice, chickpeas, field beans, mung beans, lentils, lupines, potatoes, manioc, arrowroot, flax, psyllium, almonds, cashew nuts, or a combination thereof.

13. The egg substitute of claim 1, wherein fat and/or oil is added to the egg substitute and/or the aqueous extractable fraction(s) and/or the aqueous extract(s) and amounts to up to 80% (w/w), more preferably up to 65% (w/w), more preferably up to 60% (w/w), more preferably up to 55% (w/w), more preferably up to 50% (w/w), more preferably up to 44% (w/w), more preferably up to 40% (w/w) of the dry matter.

14. The egg substitute of claim 1, wherein the protein is protein-containing flour, preferably a protein concentrate, more preferably a protein isolate.

15. The egg substitute of claim 1, wherein the egg substitute thermally solidifies, wherein the temperature range is 50° C. to 121° C., 55° C. to 100° C., more preferably between 58° C. to 99° C., most preferably between 60° C. to 90° C.

16. The egg substitute of claim 1, wherein the proportion of added legume protein and/or added legume flour in the total protein proportion in the dry matter amounts to at most 90% (w/w), preferably at most 80% (w/w), preferably at most 70% (w/w), preferably at most 60% (w/w), preferably at most 50% (w/w), preferably at most 40% (w/w), preferably at most 35% (w/w), preferably at most 25% (w/w), preferably at most 15% (w/w).

17. The egg substitute of claim 1, which before use consists of two components stored separately from each other, wherein at least one component is present in dehydrated state.

18. A method for producing an egg substitute according to claim 1, wherein a part of the mixture consisting of at least one aqueous extractable fraction of a raw material, optionally with added and emulsified fat and/or oil, is mixed together with another component consisting of at least one non-legume protein and optionally of at least one added flour(s) and/or added starch(es).

19. A method of using the egg substitute of claim 1 as a gelling agent and/or binding agent in chicken-egg-free or chicken-egg-reduced cooked or baked products, more preferably scrambled eggs, omelets, quiches, tarts, soufflés, pasta products, breadcrumb coatings, sauces, creams, puddings, tiramisu, desserts, curds, pancakes, cakes, sponge cakes, muffins, meat alternatives, burger patties or comparable products.

20. A method of using the egg substitute of claim 1 in foams or gas-containing, chicken-egg-free or chicken-egg-reduced cooked or baked products, preferably meringues, macaroons, cakes, muffins, sponge cakes, brioches, vegan whipped egg whites, marshmallows, chocolate marshmallows or comparable products, preferably produced thermally and/or mechanically and preferably fixed thermally and/or by mechanically induced gelling.

21. A method of using the egg substitute of claim 1 as a stabilizer of emulsions, preferably as a stabilizer in mayonnaise, ice cream, edible ice, soft ice cream, sausage products, salad dressings, remoulades or comparable products.
